(19) United States
(12) Patent Application Publication
(10) Pub. No.: US 2008/0049258 A1
(43) Pub. Date: Feb. 28, 2008

(54) Printing Digital Documents

(76) Inventors: Manuel Angel Albarran Moyo, Barcelona (ES); Andrew MacKenzie, Barcelona (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/571,076

(22) PCT Filed: Sep. 8, 2004
(86) PCT No.: PCT/EP04/52085

§ 371 Date: Aug. 9, 2007

(30) Foreign Application Priority Data
Sep. 10, 2003 (GB) 0321167.9

(51) Int. Cl. G06F 3/03

(52) U.S. Cl. 358/3.28

(57) ABSTRACT

A method of processing a digital document (100) which comprises content and a pattern of position identification markings comprises providing at least one electronic record of a digital document from which a second document can be produced containing substantially the same content as the digital document. The electronic record, which is preferably stored on a server (304) connected to a network, also includes information relating to the pattern printed in the digital document. The method further includes the steps of receiving a document request, the request including pattern information retrieved from the digital document (100) using a pattern reading device (300), accessing the electronic record which includes pattern information that corresponds to the retrieved pattern information and transmitting the electronic record in response to the receipt of the document request. The transmitted information may be used to generate a copy of the printed digital document (100) which includes any markings made on the document (100) with a digital pen (300).

### FIELD OF THE INVENTION

This invention relates to printing digital documents, and to digital pen and paper systems—sometimes called pen computing—in which documents are produced which include position identification pattern made up of markings printed on the document which can be detected by a suitable detection system and used to distinguish different positions on the documents.

### BACKGROUND OF THE INVENTION

It is known to use documents having such position identification markings in combination with a digital pen having an imaging system, such as an infra red camera, within it, which is arranged to image a small area of the page close to the pen nib. The digital pen includes a processor having image processing capabilities and a memory and is triggered by a force sensor in the nib to record images from the camera as the pen is moved across the document. From these images and information about the pattern the pen can determine the position of any marks made on the document by the pen. The pen information describing markings on a digital document can be stored either directly as graphic images, or perhaps as a sequence of pen markings or strokes, the position of the markings on the digital document and the time at which they were made. This pen information can be passed from the pen to a suitable processor such as a personal computer.

The combination of the pen and the patterned paper allows, for example, forms with checkboxes on to be provided and the markings of the check boxes with the pen detected. In further applications the pen markings recorded by the pen may be analysed to recognise handwriting characters.

For such a system to be able to handle a large number of documents it is desirable for the system to be able to print a different pattern on every document. In this way, the pen cannot only tell where it is on a document but also what document it is. The size of the pattern, its so-called area in pattern space, should be made very large and the allocation of portions of the pattern to documents recorded. By recording the identity of a portion of pattern allocated to each document on a database held on a server, which can be cross-reference with the pen readings, a very flexible and powerful system can be achieved.

An example of a system which employs this type of digital paper is known from Anoto AB, and information about the requirements for a suitable pattern can be found on their website at www.anoto.com.

At present, production of digital documents including pattern starts with the creation of an original document which contains some content using a document design tool. A portion of pattern is allocated to an area of the document and a name allocated to the document is stored on a remote server or application service handler (ASH) along with the identity of a portion of pattern that is allocated to the document by a pattern allocation unit. A dedicated processing application or paper handling application is also created which is stored on a local server and provides information about how to handle markings made in the patterned areas. The location and identity of this application is also stored on the server. Whenever a pen reads pattern from the paper, it contacts the ASH which sends back the location of the paper application and the name of the document. The pen information is then sent to the correct paper handling application for processing.

### SUMMARY OF THE INVENTION

According to a first aspect the invention provides a method of processing a digital document which comprises content and a pattern of position identification markings; the method comprising providing at least one electronic record of the digital document from which a second document can be produced containing substantially the same content as the digital document, the electronic record also including information relating to the pattern printed in the digital document, receiving a document request, the request including pattern information retrieved from the printed digital document using a pattern reading device, accessing the electronic record which includes pattern information that corresponds to the retrieved pattern information and transmitting the electronic record in response to the receipt of the document request.

Most preferably the method may include a step of modifying the original document to form a modified digital document which is printed, the stored electronic record containing information about the modifications such that the printed modified document can be reproduced on request from the record.

By modifying a digital document prior to printing we may mean editing the document to add more content, remove content, change content or alter the layout or form of a digital document whilst it is in the electronic domain.

By providing at least one, and preferably a set of many different electronic records from which a printed modified digital document can be recreated together with an indication of the pattern a powerful way of processing digital documents is provided. It is simple to provide a person making a request with enough information to reproduce the printed digital document by cross-referencing a request including pattern information with the pattern information of the electronic record. Anyone reading a document can request the appropriate record and from this reproduce a copy of the digital document.

Storing modifications made to the document in the digital domain enables a user to recreate the document that was printed including any modifications made to the document during printing or just prior to printing. Modifications can be of several types. For instance, the modifications may be to the way in which a document is printed. An example would be the alteration of a document such that it is printed in a landscape or portrait form. Another example would be an instruction to print the document in monochrome when the original contained colour.

Some of the modifications may alter the content of the original document. For example, an original digital document, after it has been initially created, may be edited to include extra content. A form, for example, could be personalised to form the modified document by adding extra content such as a name or address.

Other modifications may alter the way it is printed, and as such be printer commands that tell a printer how to print the document. Others may be modifications to the format of the document. The method may comprise including information about all or a combination of one or more of these as a part of the electronic record. This ensures that the printed modified document can be reprinted such that it appears to be substantially the same.

Without storing an electronic record that includes such modifications made at, or just prior to print time the exact document as printed could not be reproduced. In at least one embodiment the record may store all the information needed to reproduce the printed document in exactly the same form so that WYSIWYG. This may, as already stated go so far as storing printer settings or commands associated with the modified digital document when printed, or even a record of the make and type of printer it was printed on since this may affect the appearance of the modified printed document.

It is envisaged that the method will have many uses. An insurer, for example, could provide a customer with a claim form. This may contain content which is unique to that customer, such as their name. A unique pattern may be allocated to the customer's form and a corresponding electronic record created. The customer form is therefore enabled for a digital pen and paper system. Now, whenever the insurer receives pen information from the customer who has completed the form with a digital pen the insurer can reproduce the customer's form from the electronic record. All that need be done is for the insurer to perform the steps of the method of the first aspect of the invention.

The method may further comprise generating a second document from the information contained in the electronic record and printing the second document or displaying it on a screen. It could be printed as a digital document. In the example of the insurer, this would allow a claims handler to view the form that was given to the customer including the customer specific information. This second document can be viewed at any time and may provide a replica or preview of the printed document in which WYSIWYG. In this embodiment, the viewed document could be considered to be a preview of the printed digital document, with the additional advantage that it can be viewed long after the document has been printed and, as will become apparent, that has been updated with additional information obtained from a digital pen that has marked the printed document.

The method may include a step of including in the second document when displayed or printed markings made upon the digital document by a digital pen. This may be performed by whosoever the transmission is sent to, but could equally be performed at the server which receives document requests.

The method may also comprise storing an electronic record which comprises an exact or near exact copy of a digital document with or without pattern. The electronic record may comprise an image of the digital document, either with or without pattern. This may be stored in a variety of formats although a preferred format would be in the portable document (PDF) format. It could be stored as a bitmap or other uncompressed or compressed image such as jpg, bmp, tif, and gif.

If it is an exact copy, staying with the example of the insurer, an exact duplicate of the form complete with the customer's information can be printed or viewed.

The electronic record may further comprise information which is additional to that which is present in the printed digital document, yet which facilitates the reproduction of the digital document such as the source of content used to generate the document. For example, the electronic record may include information identifying a template and identifying variable data which has been fitted to the template to create the document.

This enables the document to be reproduced by reconstructing it from information identified by the record. Continuing with the example of the insurer, the template may be a template for a generic form whilst the variable data may be a customer name added to the form when sent to a customer.

It will be understood that the electronic record need not include the pattern in the same file as the information which relates to content. Indeed they could be separate files, stored in different locations yet related in such a way that the pattern is linked to the appropriate content information.

According to a second aspect the invention provides a method of processing a digital document which comprises content and a pattern of position identification markings; the method comprising printing the digital document, storing an electronic record of the digital document from which a second document can be produced containing substantially the same content as the digital document, the electronic record also including information relating to the pattern printed in the digital document, receiving pattern information retrieved from the digital document using a pattern reading device, accessing the electronic record which includes pattern information that corresponds to the retrieved pattern information and generating from that record the corresponding second document.

The method may further include reading the pattern using a digital pen which is adapted to apply marks to the document and to store electronic information relating to those marks, and in which the step of generating the second document comprises including the marks in the second document.

According to a third aspect the invention provides a method of printing a digital document comprising selecting a first document, modifying the first document at print stage to produce a modified first document in which the content differs from the first document and which includes a pattern of position identification markings, and storing an electronic record from which a third document can be generated which contains substantially the same content as the modified first document, the electronic record also containing corresponding information defining the pattern used when printing the modified first document.

By storing an electronic record that includes modifications or edits made to an original document at print time or just before printing, for example customisation or personalisation content of the document , anyone can subsequently obtain an electronic copy of the document as printed provided they can access the records. In this way, the stored copy will always be updated with any changes, i.e. WYSIWYG.

According to a fourth aspect the invention provides a method of printing a digital document which comprises content and a pattern of position identification markings; the method comprising receiving a document to be printed as a digital document, generating an electronic record of the document to be printed from which a second document can be produced containing substantially the same content as the digital document, the electronic record also including information relating to the pattern printed in the digital document, and transmitting the electronic record to a server which forms part of a digital pen and paper system for the processing of information from digital pens.

The method may save an electronic record which is a copy of the content of the document exactly as printed, which may replace the original stored document. In an alternative, a list of modifications may be stored which together with the original stored document enable the modified document to be reproduced.

The method may include a step of prompting a user to modify the document between initiating printing of the document and it being printed. The method steps may therefore be implemented by an appropriate printer driver. The method may permit many modifications to be made, and a non-exhaustive list of suitable modifications includes scaling, rotating, printing in monochrome rather than colour (where the content of the original is in colour).

The electronic record may be stored in an area of memory such as a floppy disk or a hard disk or a compact disk CD or DVD. In a more useful and involved embodiment it may be stored on a remote server which may provide the functionality of an application service handler in the Anoto system referred to earlier in this text. Of course, in a simpler system the server may just store the electronic record and have no link to a paper handling application. Indeed, the method is applicable to digital paper systems which do not required specific applications to handle documents and may simply be used to view copies as printed.

According to a fifth aspect the invention provides a system comprising a plurality of electronic records and associated pattern information, each electronic record corresponding to a different digital document which comprises content and at least one pattern of position identification markings, and each electronic record comprising information from which a copy of the digital document corresponding to that record can be reproduced which includes substantially the same content as the digital document.

Each electronic record and its corresponding pattern may comprise separate, related, files or a single file. The electronic records and associated pattern information could be stored on a server in such a way that the patterns can be searched upon receipt of pattern information from a digital pen used to read a digital document so as to identify which, if any, of the records corresponds to the digital document read by the pen.

The system may further include means for displaying or printing the copy of the digital document which is reproduced. A monitor may be provided for display, or a printer such as a laser printer may be provided if a hard copy is required.

The electronic record may comprise an identical or near identical copy of a corresponding digital document as printed either with or without its pattern.

The system may include an area of memory in which the records are stored. They may be provided in a database which permits the patterns to be searched.

According to a sixth aspect the invention provides a digital document printing system comprising:

a print application which is adapted to receive a first document to be printed;

a pattern allocation unit which is arranged to allocate pattern to the document to be printed; and

a storage area in which the system is arranged to store an electronic record which contains sufficient information to enable the content of the document to be at least partially reproduced together with an indication of the identity of the pattern allocated to the document.

The storage area for the electronic record may comprise memory which can be accessed by a server which is connected to the print application across a network.

The apparatus may further include a printer which prints the digital document provided by the print application comprising the original document and the allocated pattern.

According to a seventh aspect the invention provides a digital document processing apparatus comprising a pen which produces pattern information retrieved from a printed digital document, a processor which receives the pattern information from the pen, a document request means which is adapted to send a request for document information across a network, the request including the pattern information, a response receiving means for receiving a response to the request which includes an electronic record which corresponds to the digital document corresponding to the information in the document request, and in which the apparatus is adapted to generate a copy of the digital document whose pattern has been read by the pen from the electronic record.

The apparatus of this aspect may also be adapted to print the copy or to display the copy on a screen.

This apparatus enables a user to read the pattern on a digital document, and then retrieve a copy of the document for display or reprinting by sending a request for the electronic record. The request may typically be sent across a network to a server which stores the electronic records. This may occur automatically whenever a pen is used by a user to read pattern from a digital document.

It is preferred that the pen is adapted to apply marks to the digital document and to generate electronic information relating to those marks. These marks may be passed to the processor which may then generate a second document which includes the marks made by the pen. In this manner, a copy of the digital document can be displayed which also includes the markings.

According to an eighth aspect the invention provides a data carrier which carries a computer program which when running on a processor causes the processor to provide the apparatus of any one of claims 16 to 18 or any one of claims 19 to 21 or to perform the method of any one of claims 1 to 10.

According to a still further aspect the invention provides a combination of an electronic record and corresponding pattern information for use in the method of any one of claims 1 to 10. It also provides an electronic record which is to be stored with related pattern information or which may itself include related pattern information.

### BRIEF DESCRIPTION OF THE DRAWINGS

There will now be described, by way of example only, several embodiments of the present invention with reference to the accompanying drawings of which:

FIG. 1 shows a document printed according to an embodiment of the invention;

FIG. 2 shows in detail part of the document of FIG. 1;

FIG. 3 shows an embodiment of a computer system arranged to process information from the form of FIG. 1;

FIG. 4 shows a known pen for use with the document of FIG. 1;

FIG. 5 shows an apparatus for creating the document of FIG. 1 according to an embodiment of the invention;

FIG. 6 is a flowchart of the steps followed in the creation of a suitable document for printing along with an electronic record of the document in accordance with an embodiment of the present invention;

FIG. 7 illustrates an embodiment of a print apparatus suitable for printing the document in accordance with an aspect of the invention; and

FIG. 8 illustrates the flow of data when printing a merged document according to another embodiment of the present invention.

### DETAILED DESCRIPTION OF THE PREFERRED EMBODIMENTS

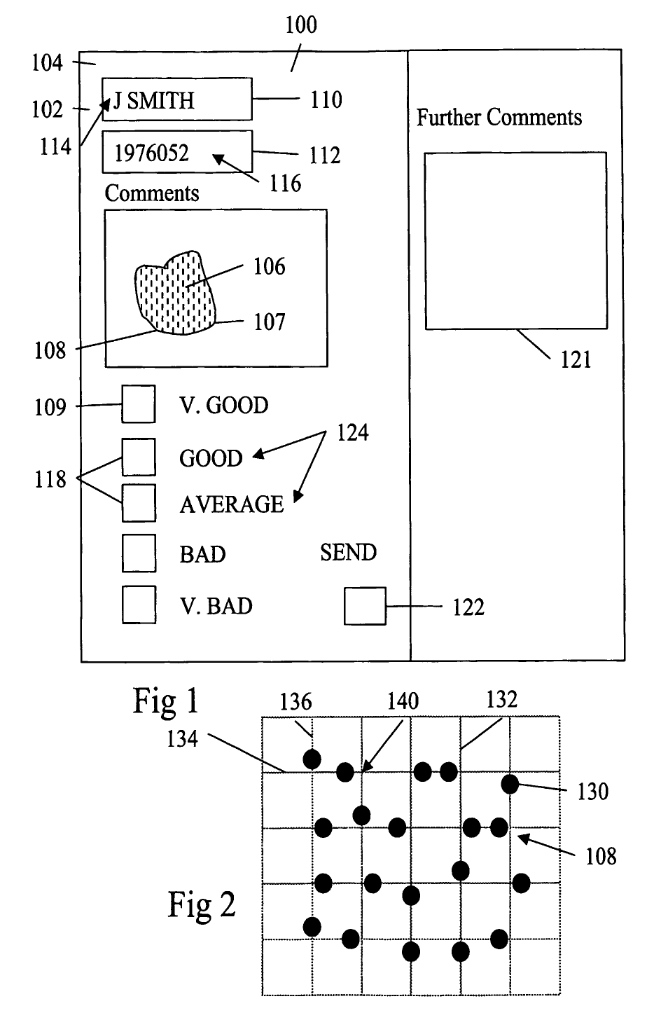

Referring to FIG. 1 a document 100 for use in digital pen and paper system comprises a carrier 102 in the form of a single sheet of A4 paper 104 with position identifying markings printed on some parts of it to form areas 107 of a position-identifying pattern 108. These background markings are referred to as “pattern” in this text. Also printed on the paper 104 are further markings 109 which are clearly visible to a human user of the form, and which make up the content of the form. The content 109 will obviously depend entirely on the intended use of the document. In this case an example of a very simple two-page questionnaire is shown, and the content includes a number of boxes 110, 112 which can be pre-printed with specific information such as the user's name 114 and a document identification number 116.

It is envisaged that the position-identifying pattern that is printed may have many forms but one suitable example is that shown in FIG. 2. The position-identifying pattern printed on the document is made up of a number of dots 130 arranged on an imaginary grid 132. The grid 132 can be considered as being made up of horizontal and vertical lines 134, 136 defining a number of intersections 140 where they cross. One dot 130 is provided at each intersection 140, but slightly offset in one of four possible directions up, down, left or right, form the actual intersection. The dot offsets are arranged to vary in a systematic way so that any group of a sufficient number of dots 130, for example any group of 36 dots arranged in six by six square, will be unique within the pattern space. An example of this type of pattern is described in WO 01/26033. It will be appreciated that other position identifying patterns can equally be used. Some examples of other suitable patterns are described in WO 00/73983 and WO 01/71643.

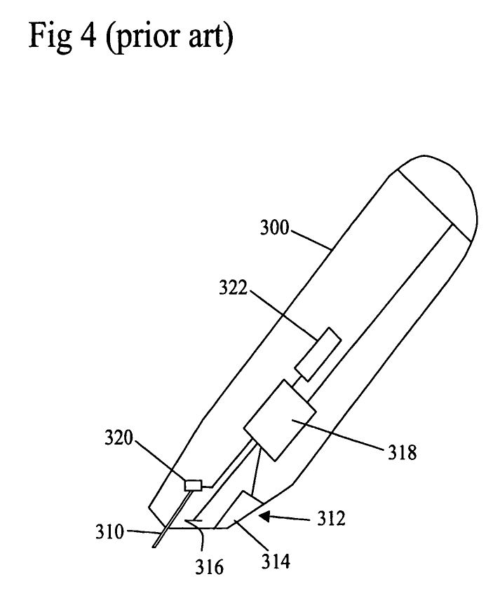

Referring to FIG. 4, a known pen 300 for use with the document 100 comprises a writing nib 310, and a camera 312 made up of an infra red (IR) LED 314 and an IR sensor 316. The camera 312 is arranged to image an area adjacent to the tip 311 of the pen nib 310. A processor 318 processes images from the camera 312. A pressure sensor 320 detects when the nib 310 is in contact with the document 100 and triggers operation of the camera 312. Whenever the pen is being used on a patterned area of the document 100, the processor 318 can therefore determine from the pattern 108 the position of the nib of the pen whenever it is in contact with the document 100. From this it can determine the position and shape of any marks made on the patterned areas of the document 100. This information is stored in a memory 320 in the pen as it is being used.

When the user has finished marking the document, in this case when the questionnaire is completed, this is recorded in a document completion process, for example by making a mark with the pen in the send box 122. The pen is arranged to recognise the pattern in the send box 122 and determine from that pattern the identity of the document 100.

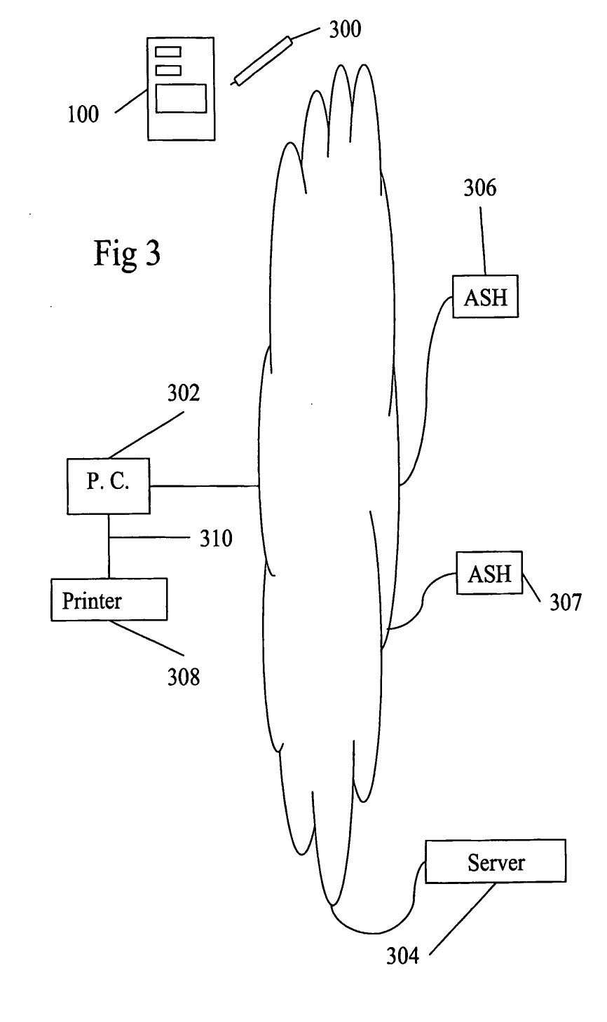

Referring to FIG. 3 an embodiment of a digital document processing system in accordance with the present invention comprises a pen 300 arranged to write on the document 100 and to detect its position on a digital document from the pattern 108, and an internet connected personal computer (PC) 302 arranged to run an application for processing data from the pen 300, for example by modifying a file in which the document 100 is stored electronically in response to pen strokes made on the document 100 with the pen 300. The PC 302 includes a user interface including a screen 314, a keyboard 316 and a mouse 318, as well as a processor, a memory, and I/O software devices by means of which the processor communicates with the screen 314, the keyboard 316, the mouse 318 and a communications port by means of which it communicates with the internet.

The system also includes an internet connected enhanced paper look up (EPLS) server 304 which has stored on it a set of electronic records which each correspond to a different printed digital document 100. Each of the electronic records in this example comprises an image file which comprises an image of the document as printed, such as a bitmap. The records also include information about the pattern printed with each digital document.

Importantly, this pattern information is stored in a searchable form. An application service handler (ASH) 306, which is a program run, in this case, on a separate server having its own memory, processor I/O devices and communications port, is also provided with Internet connection. The ASH 306 is arranged to interpret the pen strokes recorded by the pen 300, as described below, converting them to an input suitable for the application on the PC 302. The ASH includes an intelligent character recognition (ICR) program so that it can interpret handwritten input on the document 100 and convert it to digital text. A further ASH 307 is also provided, and is associated with a different application and arranged to interpret pen strokes for that application. Basically there is one ASH for each application that makes use of the digital pen and paper system.

Each ASH 306, 307 needs to have a record of the layout of any particular document 100 including the positions, dimensions and functions of each of the patterned areas so that it can process any pen strokes made on the document 100. This record can be retrieved by the ASH from the EPLS 304 when needed.

Referring again to FIG. 4, once the pen 300 has read pattern information from a digital document and the send box has been ticked it must send this document identification information to the EPLS 304. A local paper lookup service is provided on the PC which provides this functionality in the system. This is a program arranged to receive data from the pen when the pen has been used on the document 100, the data identifying which areas of pattern space have been written on. Typically the pattern space that is associated with the send box 122, and which the pen 300 has recognized as a prompt to contact the LPLS, is identified to the LPLS.

The LPLS is arranged to pass the pen information as a document request to a pattern allocation unit which forms part of the EPLS 304. One function of this unit is to receive these document requests. The requests include pattern information read from a digital document. The pattern allocation unit then searches the stored pattern information stored on the EPLS to identify the stored electronic record which corresponds to pattern information in the document request. The EPLS identifies the appropriate ASH 306 for use in processing the identified document and sends the digital document identity to the pen as well as the electronic record of the printed document. The pen can then send the pen stroke data and the document identity to the correct ASH 306, 307. The bitmap can be rendered on a screen or printed.

It will be understood that the various components of the system can all be located at separate locations, communicating via the internet as described. Alternatively some or all of them could be provided together on a single server, or grouped on a local network. This might be appropriate where a self-contained system for a limited number of applications is required. In this example, the pattern allocation unit and the store of published document data including electronic records are provided by a single EPLS server.

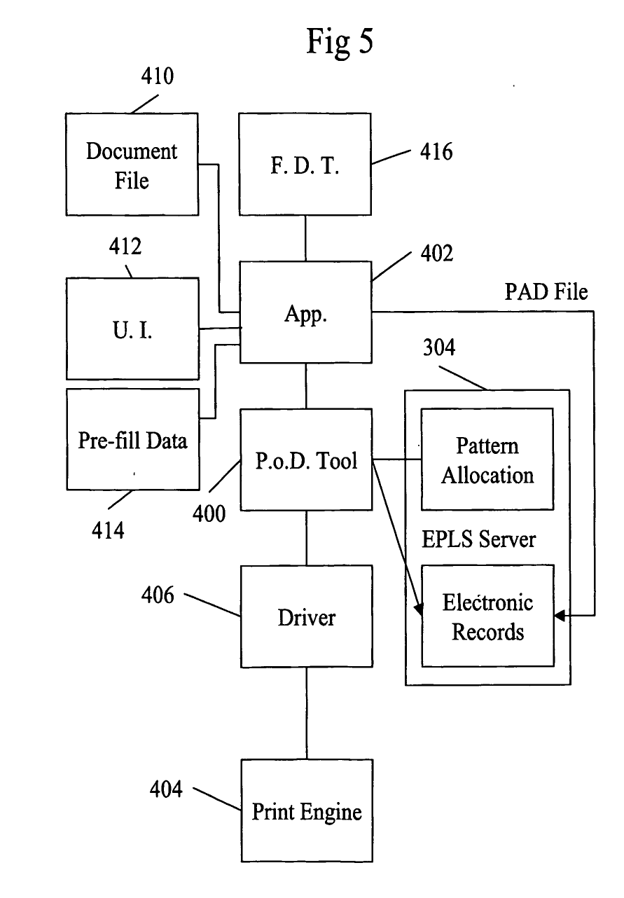

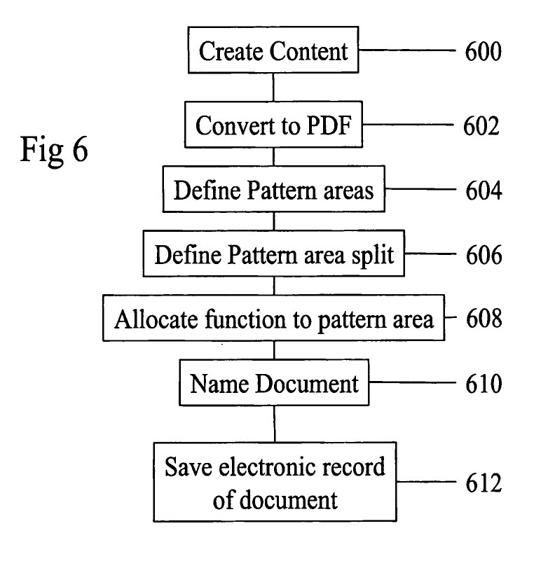

In order to produce a set of digital documents 100 and an electronic record for storing in the server of the apparatus of FIG. 5, the first step is the design and creation of the document content. Referring to FIG. 6 this starts at step 600 with the design of the content of the document, which is carried out on the PC using the application 402 or some other application. In this case the application is Acrobat Reader and the PC 302 also runs a number of other applications including a word processing package such as ‘Word’ a database package such as ‘Access’, and a spreadsheet package such as ‘Excel’. Each of these can be used to design the content of the document. In a typical use of the invention, data from a database is fitted to a number of fields in a template to produce a personalised document. Then the areas of the document to which the pattern 108 are to be applied are defined by the user. In a simple case pattern is only used to identify a digital document but in other cases two or more areas of pattern could be given different functions. In each case this is carried out using a form design tool (FDT) 416 in the form of an Acrobat 5.0 plug-in. The content is therefore converted to PDF format at step 602, and the pattern areas defined using the FDT 416 at step 604, producing a digital document defining both the content and the positions and shapes of the pattern areas.

The user may split the pattern between different pattern areas as needed (step 606) and optionally define functions associated with the various patterned areas defined at step 608 so that the application 402 can process data received back when the document 100 has been written on. In the case of the questionnaire document 100 the pattern areas in the larger boxes 120, 121 are identified as a graphical input areas, for which any pen markings should be stored graphically, or perhaps analysed using character recognition and stored as text. The pattern associated with the check boxes 118 is associated with the respective response options so that the checking of the boxes 118 on a number of the forms 100 produces a standard mark, such as a cross, in the check box of the stored document. The pattern associated with the send box 122 is associated with the send function which will cause the pen to stop recording pen strokes for the document 100 and send them to the ASH 306. The document is then named at step 610.

Once the document 100 has been named, the user indicates, using the FDT 416 that it is completed, and the FDT 416 produces and saves a copy of the document which is an electronic record of the content of that document as it will appear when printed. The electronic record may at this stage be an exact copy of the document as it will be printed and can be saved in any one of a number of preferred formats but in this example it is saved as a bitmap image. Otherwise, it could contain the content only without the formatting. It will also be understood that the pattern could be stored separate to the electronic record in some related way. As long as the pattern can be searched and is linked to its corresponding electronic record the record will still be linked to its corresponding printed digital document.

As well as the electronic record, the FDT may optionally also create a Paper Application Definition (PAD) file which is a file defining those features or parameters of the document 100 that will be needed by the ASH 306 to interpret pen strokes made on the document 100. Those parameters may include the size and shape of the pattern areas, their relative positions in pattern space as indicated by a unique pattern ID or perhaps a seed for producing the portion of pattern, and their functions, such as whether they are check boxes, areas for graphical input, areas for ICR analysis or areas having other functions. These parameters are the ones necessary to allow the processing of pen strokes made on the document 100 using the pen 300. It will, of course, be understood that the electronic record may form part of the PAD file.

The electronic record—and optionally the PAD file—is then transmitted at step 610 to the EPLS 304 when the document 100 has been finished and printed and before it is written on with the pen, so that the ASH can interpret pen strokes on the document 100 and produce the necessary inputs to the application 402. The electronic record enables the digital document to be reproduced either on a display screen or as hardcopy as it is printed.

When combined with pen stroke information by an appropriate application service handler this can enable a user to view a copy of a printed document together with the pen markings and if desired produce a copy of the originally printed document with the markings.

From the preceding description it can be seen that the EPLS server receives document requests which comprise pattern information, finds the electronic record which includes pattern which matches this request and transmits this to the PC making the request or perhaps to another device which is running an appropriate ASH. The PC, or the ASH, then generates the copy from the electronic record and combines it with any pen markings recorded by the pen. This can then be displayed on a monitor associated with the PC.

A method and apparatus for the creation of the electronic copies and printing of digital documents will now be described. The printing of the digital document—comprising the content and the pattern may be achieved in a single pass process using any printer that has a sufficient resolution to produce the dots of the pattern.

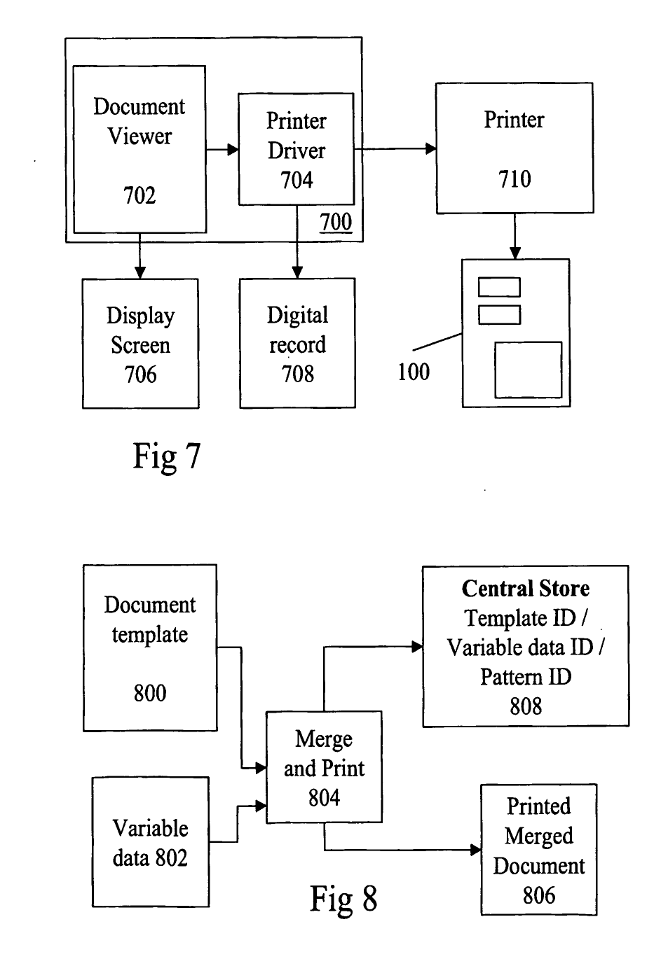

FIG. 7 shows an overview of the functional units of one embodiment of a digital document printing system in accordance with an aspect of the invention, which basically comprises a computer 700 that the document is stored on prior to printing and a printer 710 which is connected to the computer. The computer provides an application 702 for viewing and/or editing the document to be printed (typically the same FDT used to create the form) and a printer driver application 704 which produces a set of print instructions. The printer 710 includes a print controller which receives the print instructions from the printer driver and in turn prints the document. It will be understood that the printer and the computer hardware are standard whist a novel piece of software is provided on the computer which causes it to print in accordance with one aspect of the invention.

When a user decides to print a document, the printer driver or print on demand (POD) tool is called up from the application. In a typical graphical user interface, such as Microsoft Windows, running a word processing package to design a form, such as Word 6.0, calling the printer driver is performed by selecting “file” then click “print” in the drop down box that appears below. This will cause the printer driver to display a set of visual prompts on the screen to which the user can respond. These prompts may include the option to print the document with or without pattern.

Once the user has responded to the prompts called by the POD tool, a form of printer driver, it takes the file—a PDF file in this example—produced by the application and produces a print file in a page description language (PDL) describing the arrangement of any text and graphics forming the content in the document. Many different PDL languages could be used such as PCL developed by Hewlett Packard or Postscript developed by Adobe Systems. If one has not already been created before printing the printer driver may also produce a suitable electronic record, which in this example is a bitmap. It could of course be provided in some other format such as PDF. This is sent to the EPLS server. If the content has changed since the document was designed, there will be a difference between any copy reproduced from the electronic record and the actual printed document. To overcome this, a new electronic record 708 may be produced at this stage and stored on the EPLS 304. This may be stored as a replacement for any existing description held on the EPLS, perhaps as part of the PAD file. In this manner, the copy of the printed file retrieved from the EPLS is as near as possible to the printed document—including requested changes such as scaling or colour selection. If the copy is viewed on screen or printed it will be much closer to the actual printed document.

In an alternative or additional to the storage of an electronic record which is an exact copy of the printed document, the electronic record may comprise one or more identifiers which identify information relevant to the production of the document. For example, in the case of a form which is made by merging data from a database into fields of a template the electronic record may also indicate the identity and/or location of a template and also the identity and/or location of data added to the template to create the document. It may also include information about any printer settings used in printing, for example that would change the scale or format of the document, or perhaps alter the colours used when printing.

In this alternative, or in addition, the electronic record may contain enough information to not only allow the document to be reproduced but also encodes other information which is needed to reproduce the document yet can not be determined merely from looking at the printed document, such as the use of a certain template or location of a database which holds the added data. This is shown by way of example in FIG. 8 of the accompanying drawings in which a template 800 is merged with a portion of variable data 802 by a merge application 804. The merged document 806 is sent to print together with a portion of pattern, and an electronic record 808 of the document is saved on a central store or server for subsequent use.

It will be understood that the electronic record may be held in many forms and in a number of different possible locations. If the printing and writing on the documents is performed within a closed system such as an internal company workflow the record could be saved on a local disk. If the paper is to form part of an open system and could be used by any one, anywhere in the world, the record should be saved in a place where it can be accessed globally across a network. This could be on a server which provides a local paper look up service, or together with an ASH which is known to an EPLS server.

1-30. (canceled)

31. A method of processing a digital document which comprises content and a pattern of position identification markings; the method comprising modifying the digital document prior to printing to produce a modified digital document, providing at least one electronic record of the modified digital document from which a second document can be produced containing substantially the same content as the modified digital document, the electronic record also including information relating to the pattern printed in the modified digital document, receiving a document request, the request including pattern information retrieved from the digital document using a pattern reading device, accessing the electronic record which includes pattern information that corresponds to the retrieved pattern information and transmitting the electronic record in response to the receipt of the document request.

32. The method of claim 31 which further comprises generating a second document from the information contained in the electronic record and printing the second document or displaying it on a screen.

33. The method of claim 32 which further includes the steps of including in the second document when displayed or printed markings made upon the digital document by a digital pen.

34. The method of claim 32 in which the second document when printed is also a digital document.

35. The method of claim 33 in which the second document when printed is also a digital document.

36. The method of claim 31 in which the electronic record is a record of a digital document in which content has been modified at print time.

37. The method of claim 31 in which the second document is a preview of the digital document.

38. The method of claim 31 in which the electronic record comprises an image of the digital document, either with or without pattern such as a bitmap.

39. The method of claim 31 in which the electronic record comprises information which is additional to that which is present in the printed digital document yet which facilitates the reproduction of the digital document such as the source of content used to generate the document.

40. The method of claim 39 in which the electronic record includes information identifying a template and identifying variable data which has been fitted to the template to create the document.

41. The method of claim 31 which comprises storing an electronic record which comprises an exact or near exact copy of a digital document with or without pattern.

42. A system comprising a plurality of electronic records and associated pattern information, each electronic record corresponding to a different digital document which comprises content and at least one pattern of position identification markings, the digital document having been modified prior to printing and each electronic record comprising information from which a copy of the modified digital document corresponding to that record can be reproduced which includes substantially the same content as the modified digital document.

43. The system of claim 42 in which each electronic record and its corresponding pattern comprise separate, related, files or a single file.

44. The system of claim 42 in which the electronic records and associated pattern information are stored on a server in such a way that the patterns can be searched upon receipt of pattern information from a digital pen used to read a digital document so as to identify which, if any, of the records corresponds to the digital document read by the pen.

45. The system of claim 43 in which the electronic records and associated pattern information are stored on a server in such a way that the patterns can be searched upon receipt of pattern information from a digital pen used to read a digital document so as to identify which, if any, of the records corresponds to the digital document read by the pen.

46. The system of claim 42 which further includes means for displaying or printing the copy of the digital document which is reproduced.

47. The system of claim 43 which further includes means for displaying or printing the copy of the digital document which is reproduced.

48. The system of claim 44 which further includes means for displaying or printing the copy of the digital document which is reproduced.

49. The system of claim 42 in which the electronic record comprises an identical or near identical copy of a corresponding digital document as printed either with or without its pattern.

50. A data carrier which carries a computer program which when running on a processor causes the processor to perform the method of claim 31.
